(19) United States
(12) Patent Application Publication
(10) Pub. No.: US 2025/0333168 A1
(43) Pub. Date: Oct. 30, 2025

(54) AIRBORNE TARGET RECOVERY SYSTEM

(71) Applicant: SHENYANG JIDONG TECHNOLOGY CO., LTD, Shenyang (CN)

(72) Inventors: Jun JIANG, Shenyang (CN); Xuezhu WANG, Shenyang (CN)

(73) Assignee: SHENYANG JIDONG TECHNOLOGY CO., LTD, Shenyang (CN)

(21) Appl. No.: 19/256,847

(22) Filed: Jul. 1, 2025

Related U.S. Application Data
(63) Continuation of application No. PCT/CN2023/142981, filed on Dec. 28, 2023.

(30) Foreign Application Priority Data
Jan. 2, 2023 (CN) 202310000229.4

(51) Int. Cl. B64D 1/22; F16M 11/04; F16M 11/12

(52) U.S. Cl. CPC B64D 1/22; F16M 11/043; F16M 11/12; F16M 2200/066

(57) ABSTRACT

An airborne target recovery system deployed on a carrier, including at least one recovery device, at least one guide arm, a state observation device, and a controller. The controller, based on data fed back by the state observation device, controls the guide arm to guide a capture device to a desired state for timely capturing a target, as well as controls the recovery device to complete the recovery of a target. The recovery device, the guide arm, and the state observation device are each electrically connected to the controller.

### CROSS REFERENCE TO RELATED DISCLOSURES

The present application is a continuation-application of International (PCT) Patent Application No. PCT/CN2023/142981 filed on Dec. 28, 2023, which claims priority benefits to Chinese Patent Disclosure No. 2023100002294, filed on Jan. 2, 2023, the contents of which are incorporated herein by reference.

### TECHNICAL FIELD

The present disclosure belongs to the technical field of airborne recovery, and specifically, relates to an airborne target recovery system.

### BACKGROUND

An “airborne composite aircraft” system is an aircraft system with a significant application value. By integrating a child aircraft (hereinafter referred to as a sub-aircraft) with a performance-complementary master aircraft (hereinafter referred to as a mother aircraft or a carrier) that carries the sub-aircraft, an unmanned mother-child aircraft system with overall performance superior to that of the sub-aircraft and the mother aircraft is achieved, thereby significantly enhancing the task adaptability of an unmanned system. The concept and practical exploration of this system began in the early 1930s. At that time, the U.S. military intended to develop a reconnaissance system with extended airborne endurance by utilizing a large airship to deploy and recover a fixed-wing reconnaissance aircraft. A series of failed tests demonstrate that the aerial recovery of the sub-aircraft poses the greatest obstacle to constructing the unmanned mother-child system. In the 1950s, the proposed combination of the U.S. military for a large fixed-wing bomber and a small escort fighter aircraft in the mother-child aircraft system encountered the same issue and ultimately failed. The failures in exploring the unmanned mother-child system during these two periods indicate that “airborne recovery” is the crux of establishing the unmanned mother-child system.

### SUMMARY

According to a first aspect of the embodiments of the present disclosure, an airborne target recovery system is provided. The system is deployed on a carrier and includes: a recovery device, including a cable and a cable drive device for releasing and retracting the cable, a tail end of the cable provided with a capture device; a guide arm, with a free end selectively connected to the capture device; a state observation device, configured to acquire a state of a target; and a controller, wherein the controller controls, based on information fed back by the state observation device, the guide arm to guide the capture device to a desired state, so as to allow the capture device to implement the capture of the target timely; and controls the recovery device to complete the recovery of the target, where after ensuring that the capture device can capture the target and making the capture device and the target detached from the guide arm, the controller enables a target load to act on the recovery device rather than the guide arm.

According to a second aspect of the embodiments of the present disclosure, an airborne target recovery system is provided. The system is deployed on a carrier and includes: at least one cable, with a first end connected to a carrier and a second end provided with a capture device; and a guide arm, with a free end selectively connected to one of the capture devices, wherein the guide arm guides the capture device to a desired state, so as to allow the capture device to implement the capture of a target timely; and after the capture device ensures that the target can be captured, the capture device can be selectively released, so as to allow a target load to act on the cable.

### BRIEF DESCRIPTION OF THE DRAWINGS

FIG. 1 is a perspective view of an overall configuration of an airborne recovery system according to the present disclosure.

FIG. 2 is a perspective view of an embodiment of a guide arm according to the present disclosure.

FIG. 3 is a perspective view of an embodiment of a guide arm according to the present disclosure.

FIG. 4 is a perspective view of an embodiment of a guide arm according to the present disclosure.

FIG. 5 is a perspective view of an embodiment of a support body according to the present disclosure.

FIG. 6 is a perspective view of an embodiment of a support body according to the present disclosure.

FIG. 7 is a perspective view of an embodiment of a moving device according to the present disclosure.

FIG. 8 is a perspective view of an embodiment of a passive capture device according to the present disclosure.

FIG. 9 is a perspective view of an embodiment of an active capture device according to the present disclosure.

FIG. 10 is a perspective view of an embodiment of an active capture device according to the present disclosure.

FIG. 11 is a perspective view of an embodiment of a guide device according to the present disclosure.

FIG. 12 is a perspective view of an embodiment of a storage system according to the present disclosure.

FIG. 13 to FIG. 19 are perspective views of processes of sub-aircraft recovery through an airborne recovery system according to the present disclosure.

FIG. 20 is a perspective view of recovery of aerial cargo according to the present disclosure.

FIG. 21 is a perspective view of recovery of ground cargo according to the present disclosure.

In the figures: 1—carrier; 2—sub—aircraft; 201—clamping device; 3—recovery system; 301—recovery cable; 302—cable drive device; 303—capture device; 3031—cone cover; 304—active capture device; 3041—rod body; 3042—spring; 3043—limiting block; 3044—rod body; 3045—piston; 3046—first gas injection channel; 3047—second gas injection channel; 3048—first valve; 3049—second valve; 305—passive capture device; 3051—rod body; 3052—mechanical gripper; 4, 41, 42, 43—guide arm; 401, 4011, 4012—support body; 5—engagement device; 6—docking device; 601—support rod; 602—docking portion; 7—guider; 8—storage system; 801—storage position; 802—transfer device; 9—moving device; 901—first guide rail; 902—second guide rail; 10—cargo; 11—ground stand; 1101—clamping device.

### DETAILED DESCRIPTION OF THE EMBODIMENTS

The present disclosure will be further explained in conjunction with specific implementation solutions, but the present disclosure is not limited thereto. Structures, proportions, sizes, etc., depicted in the accompanying drawings of the specification are merely to coordinate with the content disclosed in the specification for the understanding and reading of those skilled in the art, and are not intended to limit the implementable limiting conditions of the present disclosure, and thus do not have substantial technical significance. Any structural modifications, changes in proportional relationships, or adjustments in sizes, without affecting the effects the present disclosure can generate and the objectives the present disclosure can achieve, should still fall within the scope covered by the disclosed technical content of the present disclosure. Meanwhile, terms referenced in this specification such as “upper,” “lower,” “front,” “rear,” and “middle” are merely for clarity of description and not intended to limit the implementable scope of the present disclosure. Changes or adjustments in relative relationships, without substantive alterations to the technical content, should also be considered within the implementable scope of the present disclosure.

The present disclosure discloses an airborne recovery system for recovering a sub-aircraft by a carrier aircraft. The carrier aircraft here refers to an aircraft that carries the sub-aircraft or provides supplies to the sub-aircraft, also briefly referred to as a carrier 1 or a mother aircraft. The sub-aircraft 2 here refers to an aircraft that relies on the carrier to remain airborne or to achieve long range and endurance. The sub-aircraft 2 can operate independently of the carrier 1 or return to fly near and accompany the carrier 1.

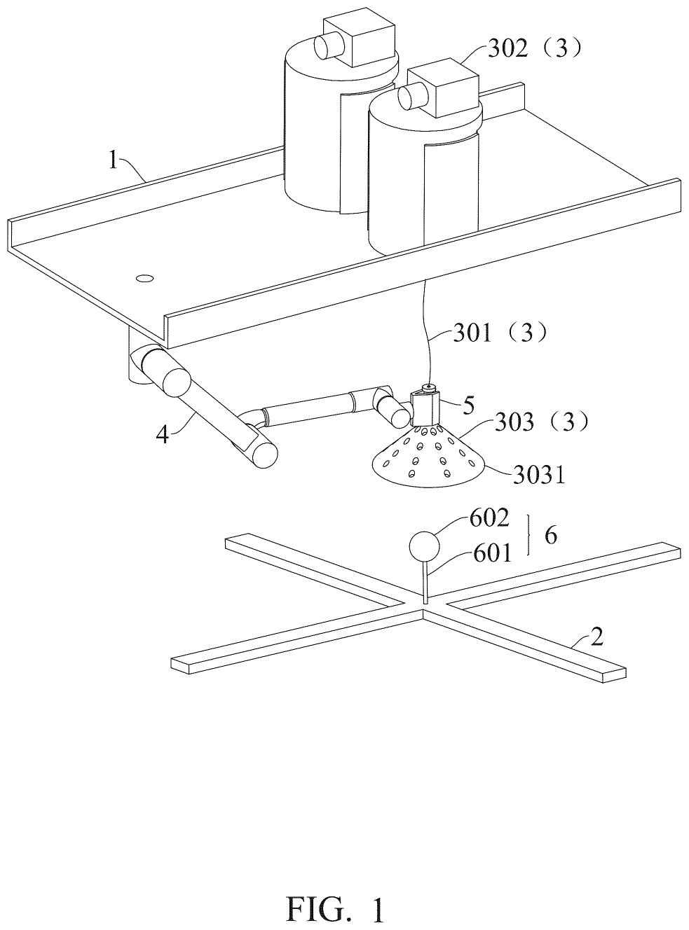

Referring to FIG. 1, the airborne recovery system includes at least one recovery device 3. The recovery device 3 includes a recovery cable 301. One end of the recovery cable 301 is connected to a cable drive device 302 mounted on the carrier 1. In the following embodiments, the cable drive device 302 is implemented using a winch. The other end is provided with a capture device 303 for capturing the sub-aircraft. After the capture device 303 captures the sub-aircraft 2, the winch retracts the recovery cable 301 and brings the sub-aircraft 2 back to the carrier 1.

The airborne recovery system also includes at least one guide arm 4, which includes a multi-degree-of-freedom mechanical arm with a dynamic control capability. A fixed end of the guide arm 4 is arranged on the carrier 1, and a free end of the guide arm 4 is provided with an engagement device 5 for engaging with the capture device 303. The engagement device 5 completes the fixed connection and release between the guide arm 4 and the capture device 303 timely. The engagement device 5 can be engaged with the capture device 303 using a clamp, an electromagnetic method, or an adsorption method. In an embodiment, the engagement device is a fastener that functions to fixedly connect the capture device to the free end of the guide arm. Relying on a high dynamic servo motion capability and high control precision of the mechanical arm, the guide arm 4 may allow the capture device 303 located thereon to effectively track a desired state, especially a desired position and a desired attitude of the capture device 303, before and during the capture implementation, and release or drive the capture device 303 timely to capture the sub-aircraft 2.

The airborne recovery system also includes a state observation device for measuring a motion state of the sub-aircraft 2. The state observation device may be flexibly arranged at a position convenient for state observation, including but not limited to: on the guide arm 4, on the capture device 303, on an airframe of the carrier 1, on an airframe of the sub-aircraft 2, and a combination of the above-mentioned positions. In addition to a device that directly acquires a relative state of an observed object, the state observation device also includes inertial sensors, etc., on airframes of the sub-aircraft and the mother aircraft, as well as a device combination and an algorithm that achieve a better state observation capability through multi-sensor fusion via communication between the sub-aircraft and the mother aircraft. In some embodiments, the sub-aircraft 2 is provided with identification points that facilitate recognition and measurement by the state observation device.

The airborne recovery system also includes a controller that guides, based on data fed back by the state observation device, the guide arm 4 to adjust a state of the capture device 303, implementing the capture of the sub-aircraft 2 timely. The controller is mainly used to run a control algorithm and send an execution instruction based on the received feedback data and other parts of information. Its carrier includes an independent controller of this recovery system, a sub-aircraft controller, a carrier controller, and a system external controller. Executed algorithms include, but are not limited to, an algorithm that only considers recovery system dynamics without accounting for carrier dynamics, an algorithm that comprehensively considers complex multi-rigid-body dynamics of the recovery system and the carrier, and a comprehensive dynamic algorithm that comprehensively considers the carrier 1, the recovery system, the sub-aircraft 2, and link environmental disturbances. A method for executing the algorithms may involve centralized computing by an independent controller, distributed computing by the above-mentioned controllers distributed in different parts, or computing by an external server. The recovery device 3, the guide arm 4, and the state observation device are each electrically connected to the controller.

In the present disclosure, a core function of the guide arm 4 is to drive the capture device 303 in the recovery device 3 to track the desired state of the capture device 303 as given by the controller, thereby maximally compensating for a state difference between the sub-aircraft 2 and the carrier 1, and further facilitating the smooth docking of the capture device 303 with the sub-aircraft 2. After the capture device 303 is docked with the recovered sub-aircraft 2, the engagement device at the tail end of the guide arm 4 releases the capture device 303 or guides the capture device to assist in recovery according to an actual application scenario. Subsequently, the carrier 1 retracts the sub-aircraft 2 through the recovery device 3. Before implementing the capture, a load on the guide arm 4 is only the capture device 303, so that after the capture, a weight of the recovered sub-aircraft 2 is borne by the recovery cable 301 and the cable drive device 302. In this case, the guide arm 4 has released the capture device 303 or only provides a guidance assistance function. Therefore, compared with a solution of recovering the sub-aircraft using a rigid recovery system, this solution reduces the weight of the guide arm by one to several orders of magnitude while ensuring that the guide arm has a sufficient dynamic motion capability. The guide arm 4 may be correspondingly designed according to actual conditions. As shown in FIG. 1, the guide arm 4 achieves the high dynamic servo motion capability and the high control precision using the multi-degree-of-freedom mechanical arm. Three of the implementation solutions are provided next.

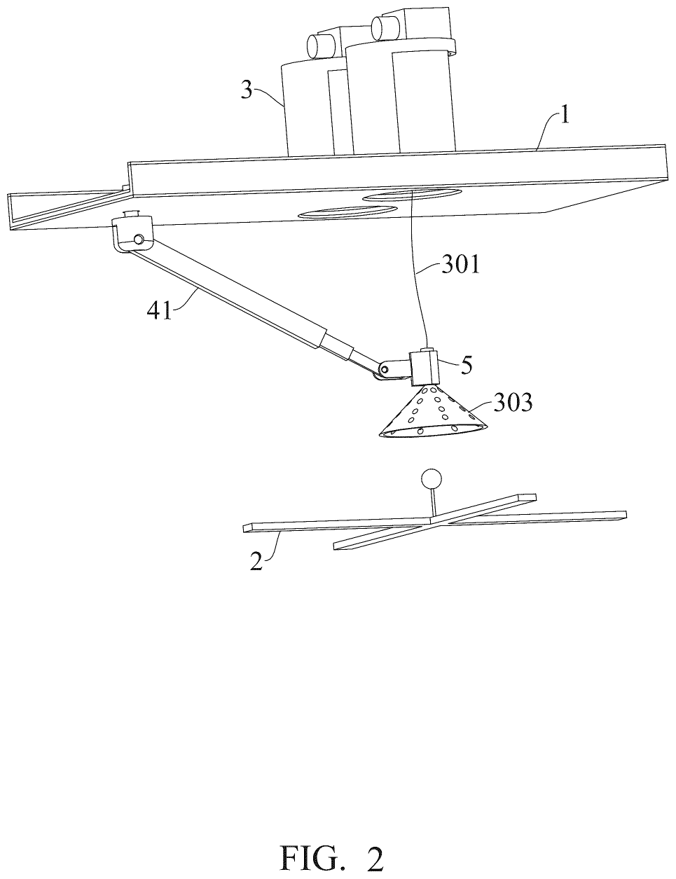

According to a first implementation solution of the guide arm in the present disclosure, as shown in FIG. 2, the guide arm 41 may be implemented through an RRP+RR-type mechanical arm. Generally, the number of attitude degrees of freedom may be determined according to a control algorithm, with the principle of achieving the function with the minimum number of degrees of freedom. In conjunction with a docking device designed as axially symmetric, a two-degree-of-freedom design is considered. The controllable engagement device for clamping the capture device 303 is arranged at the tail end of the guide arm 41. When the capture device 303 needs to be detached from the guide arm 41, the engagement device may quickly open to allow the load to separate from the guide arm 41, thereby preventing overload of the guide arm 41. When a parallel recovery operation is needed, the guide arm 41 is combined with the prepared capture device 303 through the engagement device. While the sub-aircraft 2 is hoisted in a previous procedure, the next sub-aircraft 2 is grabbed and docked.

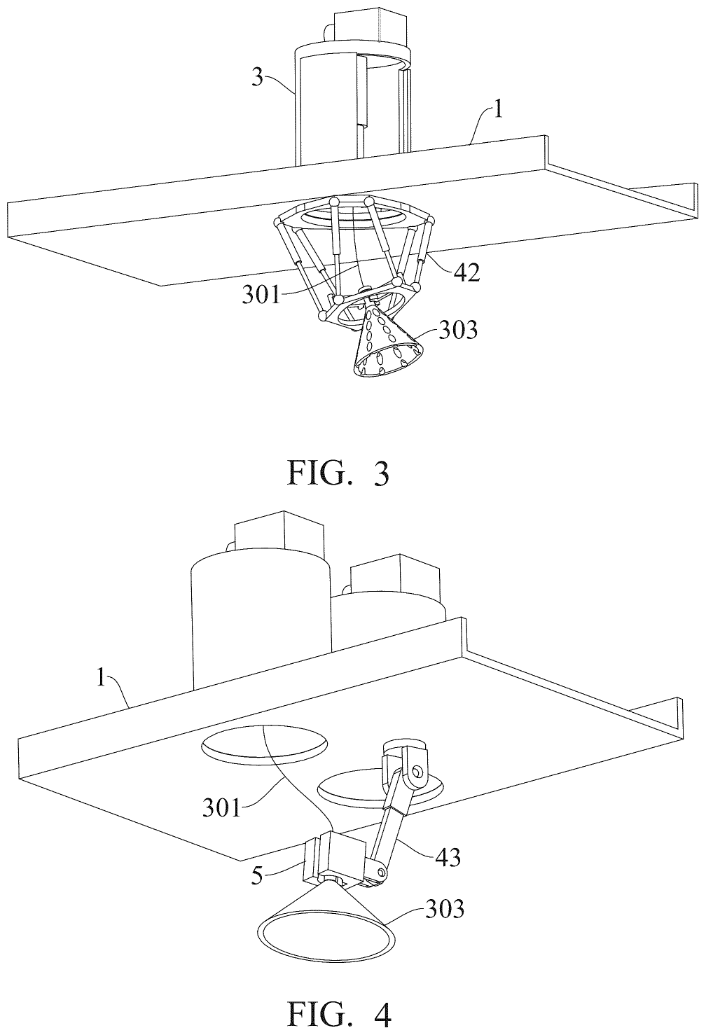

According to a second implementation solution of the guide arm in the present disclosure, as shown in FIG. 3, the guide arm 42 achieves a three-degree-of-freedom position and a two/three-degree-of-freedom attitude at the tail end in a parallel mechanical arm form. Since the parallel mechanical arm has a distributed link structure, forces on each component are more uniform in this method. Typically, such a mechanical arm is located at a lower portion of the carrier 1, and each telescopic rod usually bears tension only. From a structural design perspective, the forces are more reasonable, and the mechanism is lighter. An engagement device is arranged on a connector at a tail end of the parallel mechanical arm, and the engagement device is used for replacing the capture device 303 quickly.

According to a third implementation solution of the guide arm in the present disclosure, as shown in FIG. 4, when the relative state control precision between the sub-aircraft and the mother aircraft reaches a high level, the guide arm 43 may adopt an RRR, RRP, or RR configuration. This configuration has obvious advantages, namely, reducing the number of stages in a serial mechanism of the mechanical arm and decreasing the number of joints required in the system, and thus significantly reducing the system weight. Meanwhile, since the robot joints are one of the most costly components, this design also significantly reduces costs.

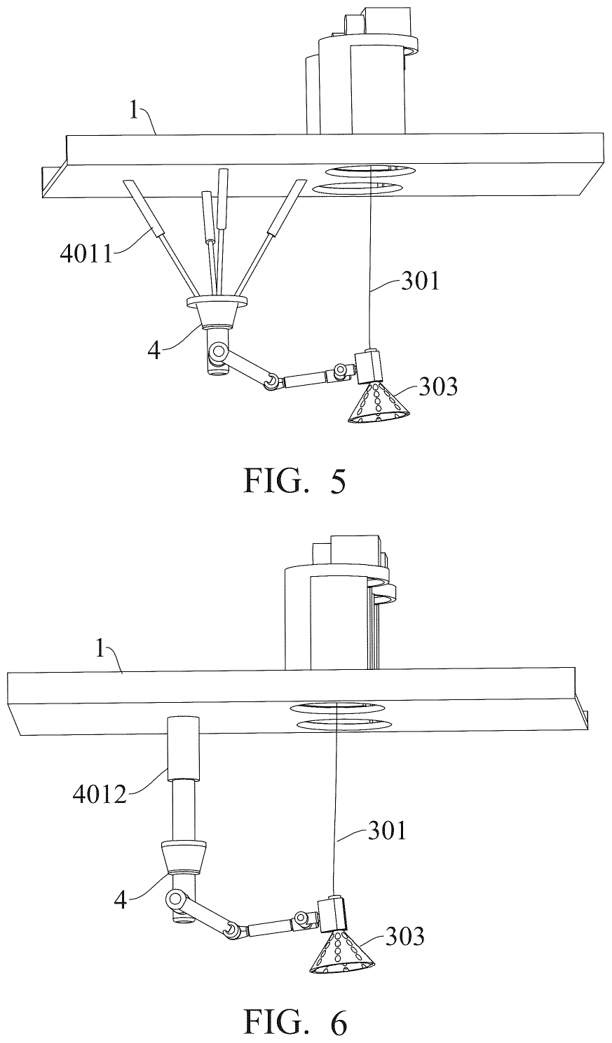

In conjunction with the above-mentioned solutions, there is a need to consider the impact of a laminar boundary layer on an airframe surface and a spacing between the sub-aircraft and the mother aircraft on the safety of formation flight as well as the recovery process. In most cases, a length of the guide arm 4 directly fixed to the airframe of the carrier 1 is much greater than a range of relative control precision between the sub-aircraft and the mother aircraft, resulting in a portion of the length of the guide arm 4 not being able to utilize the high dynamic tracking control function of the mechanical arm, while also causing a large redundant weight and unnecessarily increasing the burden on the carrier 1. For example, if the arm length is doubled and a cross-sectional dimension of an arm rod remains unchanged, the moment of inertia of the arm rod about a root becomes four times the original value. To maintain the stiffness of the arm rod, a cross section typically needs to be increased, resulting in the moment of inertia increasing by more than four times. For a servo drive, four times or more driving force is required upon the changes, which significantly increases the system weight and costs. Therefore, to further optimize this recovery system, a support body 401 is additionally arranged on the guide arm 4. One end of the support body 401 is mounted on the carrier 1, and the other end is connected to the fixed end of the multi-degree-of-freedom mechanical arm. Another function of a length of the support body 401 is to provide a large-range compensation for the mechanical arm, thereby reducing an extended length of the multi-degree-of-freedom mechanical arm, further decreasing the weight of the multi-degree-of-freedom mechanical arm, and further allowing the multi-degree-of-freedom mechanical arm to play a more reasonable role in the present disclosure. It should be emphasized that the support body 401 is not a simple addition of the extension of the multi-degree-of-freedom mechanical arm. In the present disclosure, actions of the multi-degree-of-freedom mechanical arm are more reflected in high dynamic mobility to improve the capture precision and speed of the capture device 303. During the recovery, the sub-aircraft 2 or a formation of the sub-aircraft 2 needs to maintain a certain safe distance from the carrier 1. The safe distance, in terms of the extension provided by the multi-degree-of-freedom mechanical arm, constitutes redundancy for the multi-degree-of-freedom mechanical arm. Therefore, the extension of the support body 401 compensates for the redundancy of the above-mentioned multi-degree-of-freedom mechanical arm. Through a mechanical design and installation layout, the support body 401 can allow an end-mounted payload to extend a certain distance outside the airframe of the carrier 1 to meet the requirements of the recovery operations, such as avoiding the laminar boundary layer or ensuring the minimum safe distance between the sub-aircraft and the mother aircraft. The payload may also be retracted into the airframe of the carrier 1 or to an external portion close to the airframe of the carrier 1 when there is no recovery task. When the recovery task is initiated, the support body 401 completes an extension action before the recovery implementation, entering a ready-for-recovery state. For example, as shown in FIG. 5, a support body 4011 may be of a structure similar to the parallel mechanical arm, that is formed using multi-stage telescopic rods. Specialized actuators are used to extend connectors of the telescopic rods outside the airframe or retract the connectors into the airframe of the carrier 1. Alternatively, as shown in FIG. 6, a support body 4012 may adopt a single support body or double support bodies each with a streamlined cross section. Since this telescopic section does not require a rapid dynamic control effect, its actuator may be designed as a lightweight actuator with a smaller driving force.

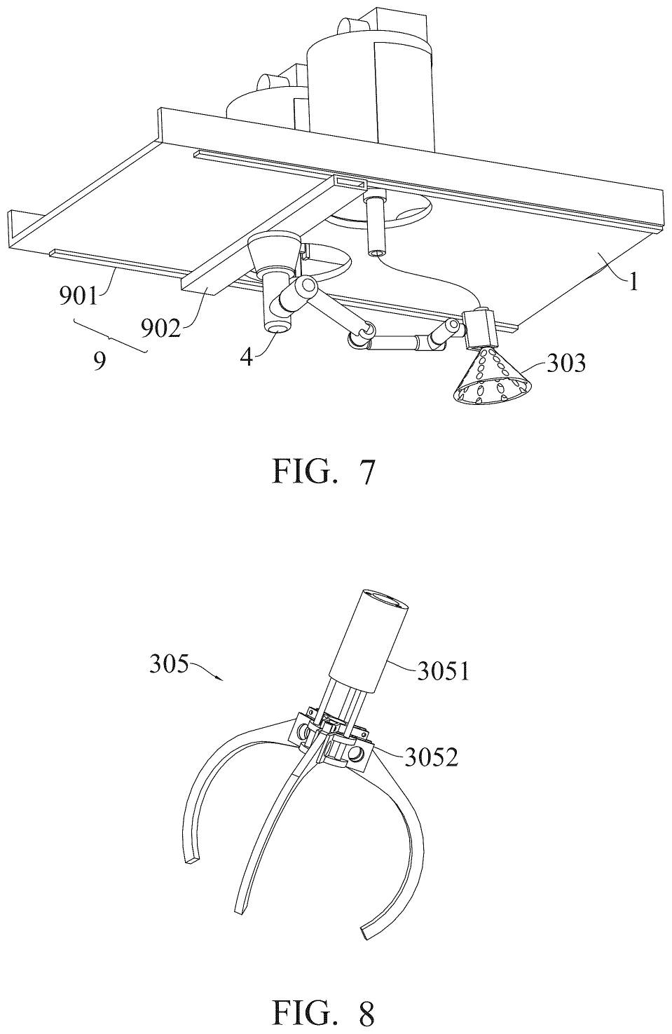

To enhance the reachability of the guide arm 4, a moving device 9 is mounted on the carrier 1. The moving device 9 may allow the guide arm 4 to reciprocate in a longitudinal direction of the carrier 1 and/or reciprocate perpendicular to the longitudinal direction of the carrier 1. Specifically, the guide arm 4 reciprocates beneath the airframe from a nose to a tail, reciprocates in a longitudinal direction of a wingspan, and extends out of and retracts into the airframe in a certain direction. The moving device 9 is fixedly mounted on the carrier 1, the guide arm 4 is arranged at a movable end of the moving device 9, and the moving device 9 is electrically connected to the controller. For example, the moving device 9 is implemented using guide rails. As shown in FIG. 7, fixed ends of the guide rails are fixedly connected to the carrier 1. The guide rails include a first guide rail 901 and a second guide rail 902 perpendicular to the first guide rail 901. The second guide rail 902 may reciprocate in a longitudinal direction of the first guide rail 901. The fixed end of the guide arm 4 is connected to a movable end of the second guide rail 902, and the guide arm 4 may reciprocate in a longitudinal direction of the second guide rail 902, and accordingly the guide arm 4 adapts to large-range operation requirements. If necessary, a telescopic device perpendicular to the longitudinal direction of the second guide rail 902 may be arranged on the second guide rail 902, or the telescopic device is perpendicular to both the longitudinal direction of the first guide rail 901 and the longitudinal direction of the second guide rail 902. The guide arm 4 is mounted at a free end of the telescopic device and may reciprocate in a telescopic direction of the telescopic device. Alternatively, a planar link mechanism is adopted to drive the fixed end of the guide arm to move on a surface of the airframe of the carrier 1 to meet the requirements of operational position switching.

The capture device has different design solutions or operational modes in different cases, and specifically, includes an active capture device 304 and a passive capture device 305, referring to an active capture and a passive capture. For example, when the action precision and motion capability of the guide arm 4 are sufficient to track a relative motion dynamic state of the sub-aircraft 2, the capture device may operate in a “passive” mode. In this case, either the passive capture device 305 or the active capture device 304 may be used. In some application scenarios, there is a high dynamic state between the sub-aircraft and the mother aircraft, making it difficult for the dynamic control capability of the guide arm 4 to effectively compensate for the relative motion state between the sub-aircraft and the mother aircraft. Therefore, in this case, the active capture device 304 with an independent active motion capability may be used to capture the sub-aircraft 2 with higher dynamics than the motion capability of the guide arm 4, thereby improving the capture success rate. For example, the active capture device 304 with a rapid motion capability can compensate for the insufficient high-dynamic tracking control capability of the guide arm 4 through rapid motion and tolerance capabilities of the guide arm, thus achieving a capture capability under high dynamics. When a dynamic state of the capture device meets capture conditions, the controller sends a signal to the capture device, and the capture device quickly rushes towards the sub-aircraft to complete the capture. The method can improve the efficiency and reliability of the capture and docking operation, and in this case, the capture device operates in the “active” mode. A locking mechanism in the capture device is triggered by mechanical or electrical signals. When the capture device captures the sub-aircraft, a sensor or mechanical switch signal is triggered. The trigger signal is sent to the locking mechanism via the controller or directly, causing the locking mechanism to quickly lock.

More specifically, the present disclosure provides an implementation of the passive capture device 305. The passive capture device 305 includes a rod body 3051, and a front end of the rod body 3051 is provided with a mechanism to grasp and lock the sub-aircraft 2. As shown in FIG. 8, in one of the embodiments, the passive capture device 305 uses a conventional mechanical gripper 3052 to implement grabbing and locking. After the mechanical gripper 3052 is docked with the sub-aircraft 2, jaws of the mechanical gripper 3052 are tightened and closed to fasten the sub-aircraft 2 and complete the capture. In the capture process, a position and an attitude of the passive capture device 305 are implemented through driving of the guide arm 4.

For the active capture device 304, for example, to enhance the capability of the guide arm 4 to capture the high-dynamic sub-aircraft recovered, the active capture device 304 may capture the sub-aircraft 2 using an impact method. One of the implementations may involve storing energy for ejection using an energy storage method. When the capture is implemented, the stored energy is released to drive the capture device to capture the sub-aircraft2. Two implementation solutions for the active capture device 304 are provided here.

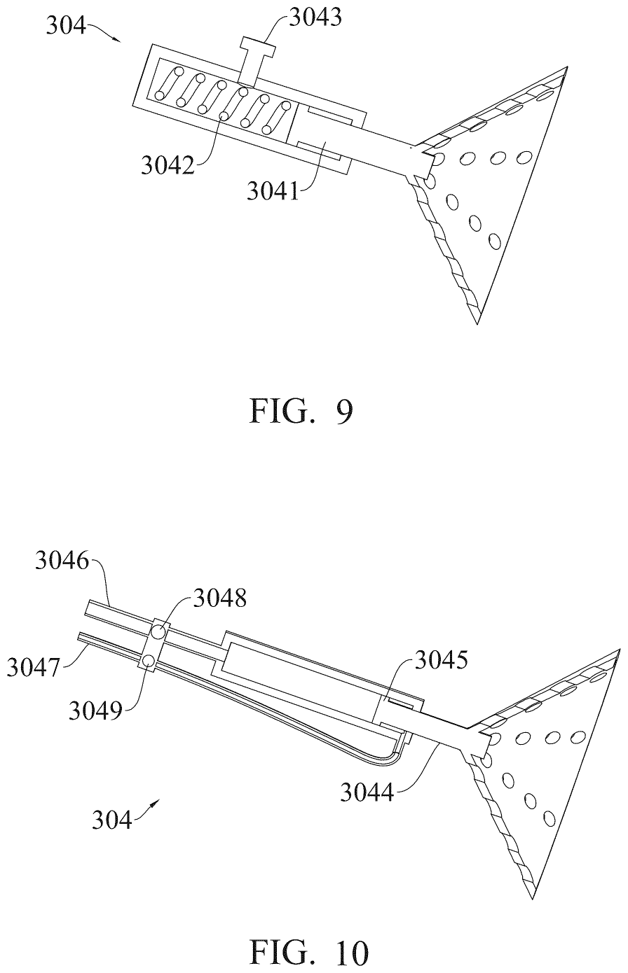

According to a first implementation solution for the active capture device 304, as shown in FIG. 9, a spring is used as an energy storage element and is compressed using a relative motion between an ejection portion and a loop in this solution. At a preset position, the ejection portion is fixed through a controllable limiting block, and meanwhile the spring is limited. When ejection is required, the limiting block is moved away through a drive method such as electric drive, thereby releasing the elastic potential energy stored in the spring. Under the elastic force of the spring, the ejection portion of the capture device rushes towards the sub-aircraft to implement the capture. Specifically, the present disclosure provides an active capture device 304, including a housing with a cylindrical cavity. A spring 3042 is arranged in the cavity. A fixed end of the spring 3042 is fixedly connected to one end of the cavity, and a movable end of the spring 3042 may reciprocate along an axis of the cavity to store and release the elastic potential energy. The housing is provided with a limiting block 3043 perpendicular to the axis of the cavity. The limiting block 3043 may be driven by an electrical signal to move away from a position blocking the ejection portion. The active capture device 304 also includes an impact portion. The impact portion includes a rod body 3041 that matches the cavity. A front end of the rod body 3041 is provided with a mechanism to grasp and lock the sub-aircraft 2. The rod body 3041 is provided with a configuration that matches the limiting block 3043, such as a limit hole. During energy storage assembly, a tail end of the rod body 3041 of the impact portion abuts against the movable end of the spring 3042, the spring 3042 is compressed into the cavity for energy storage, and then the limiting block 3043 is inserted into the limit hole in the rod body 3041 to lock the impact portion and the spring 3042 in an energy storage state in the cavity. When releasing the impact portion, the limiting block 3043 is removed, allowing the impact portion to be ejected for implementing the capture.

According to a second implementation solution for the active capture device, as shown in FIG. 10, similar to the first implementation solution for the capture device, an energy storage portion stores energy for the capture device using compressed air, and the ejection portion of the capture device is controlled through a controllable valve. When ejection is required, the controller sends an instruction to the controllable valve. The valve is opened, and the compressed gas is compressed into the cavity of the capture device through a pipeline to push the impact portion out for implementing the capture. Specifically, the present disclosure provides another active capture device 304, including a cylindrical cavity. The cavity is internally provided with a piston 3045 that can reciprocate along the axis of the cavity. The piston 3045 is in sealed connection with an inner wall of the cavity. A tail of the cavity is provided with a first gas injection channel 3046 for pushing the impact portion, and a head is provided with a second gas injection channel 3047 for retracting the impact portion. Both the first gas injection channel 3046 and the second gas injection channel 3047 are connected to a gas storage tank and an outside via a three-way gas valve. The three-way gas valve has two gears. When the gas valve is at a first gear, a gas injection channel cavity end communicates with the gas storage tank. When the gas valve is at a second gear, the gas injection channel cavity end communicates with external air. A gas valve for the first gas injection channel 3046 is a first valve 3048, and a gas valve for the second gas injection channel 3047 is a second valve 3049. The capture device also includes an impact portion. The impact portion includes a rod body 3044 fixedly connected to the piston. A front end of the rod body 3044 is provided with a mechanism to grasp and lock the sub-aircraft. Before implementing the capture, the first valve 3048 is set to the second gear, and the second valve 3049 is set to the first gear. Gas is compressed to a head gas channel through the second gas injection channel 3047, and the impact portion and the piston 3045 are moved to the tail of the cavity. When implementing the capture, the first valve 3048 is set to the first gear, and the second valve 3049 is set to the second gear, allowing high-pressure gas from the gas storage tank to quickly enter the cavity through the first gas injection channel 3046, and pushing the impact portion towards the sub-aircraft 2.

If necessary, a “counterweight” portion that matches the ejection portion is designed for the energy storage and ejection methods. During ejection, the counterweight portion moves opposite to a motion direction of the ejection portion. Ideally, the resultant force on the guide arm caused by the “impact” action of the active capture device 304 is zero, minimizing or eliminating the load on the guide arm 4 during the ejection action.

To better facilitate the capture of the sub-aircraft 2, the airborne recovery system also includes a docking device 6 arranged on the sub-aircraft 2, as shown in FIG. 1. The docking device 6 matches the capture device 303 to allow the capture device 303 to grasp the sub-aircraft 2. The docking device 6 has various structures. In one of the embodiments, the docking device 6 includes a support rod 601, and a top of the support rod 601 is provided with a docking portion 602. The docking portion 602 is of a spherical structure, a conical structure, or a structure that facilitates cooperation with the capture device 303. The other end of the support rod 601 is mounted on the sub-aircraft 2. A joint between the capture device 303 and the docking device 6 may be designed as a funnel-shaped cone cover 3031 to improve a fault tolerance capability during the capture. The cone cover 3031 is internally provided with a mechanism for grasping and locking the sub-aircraft 2. The cone cover 3031 is in a hollow design to reduce air resistance.

In one embodiment, a docking component for the above-mentioned capture device and the sub-aircraft may be interchanged. One of the methods is partial interchange. That is, a tolerance portion is placed on the sub-aircraft, and the docking portion that matches the tolerance portion is placed on the capture device. For example, the funnel-shaped cone cover 3031 of the capture device 303 and the mechanism for grasping and locking within the cone cover 3031 are mounted on the sub-aircraft 2, and the docking portion 602 of the docking device 6 on the above-mentioned sub-aircraft is mounted on the capture device 303. The other method is complete interchange. That is, the capture device 303 of the recovery device 3 and the docking device 6 of the sub-aircraft are exchanged.

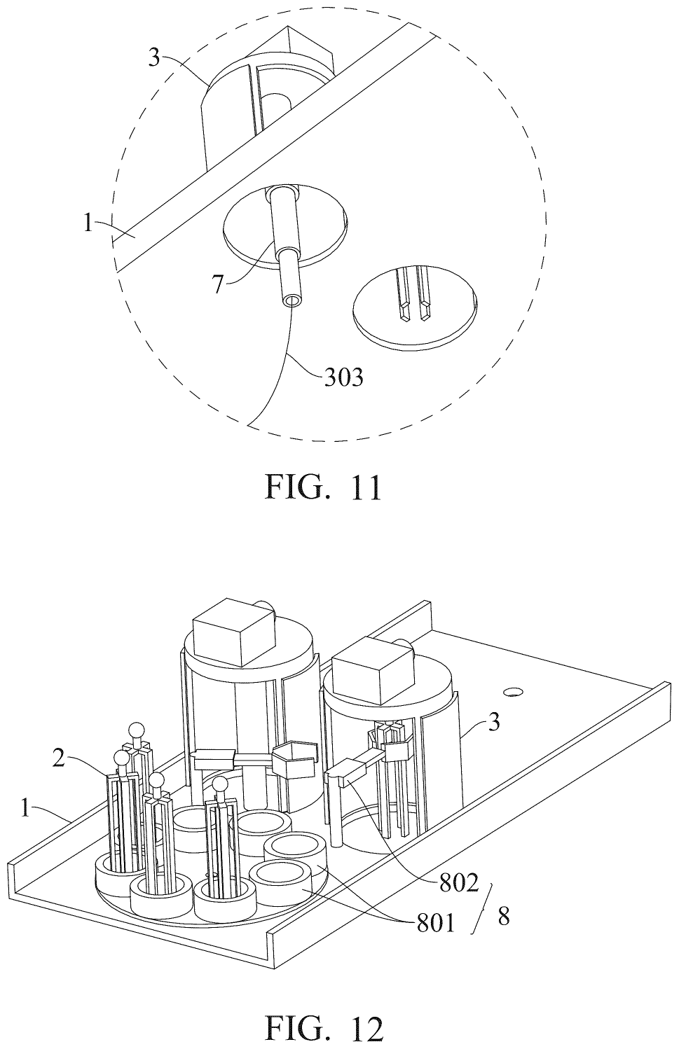

The recovery device 3 is also provided with a guider 7 for guiding the recovery cable 301 to prevent collisions between the sub-aircraft 2 and the carrier 1 during recovery. The guider 7 may adopt a multi-stage hollow telescopic rod with a guiding function, as shown in FIG. 11. The recovery cable 301 is arranged in the telescopic rod, and under the guidance of the telescopic rod, a recovery trajectory of the sub-aircraft 2 after the sub-aircraft 2 approaches the carrier 1 is set. A top of the guider 7 is fixed in a recovery chamber. After the capture device 303 is taken out, the guider 7 freely extends under the action of gravity. When the capture device 303 is recovered, the guider 7 automatically retracts as the capture device 303 enters the chamber.

The state observation device, which uses optical measurement methods typically including monocular, binocular, or multi-ocular camera shooting and visual methods, identifies and measures marker points through a graphical method. Radar, millimeter wave, ultrasonic positioning, satellite positioning, and integration of the above-mentioned methods with combined navigation may also be used.

The airborne recovery system also includes a storage system 8 for transferring and storing the recovered sub-aircraft 2. The storage system 8 is arranged in the carrier 1 and includes at least one storage position 801 and a transfer device 802 for transferring the recovered sub-aircraft 2 to the storage position 801. The storage system 8 is electrically connected to the controller. In one of the embodiments, as shown in FIG. 12, the transfer device 802 includes at least one multi-degree-of-freedom transfer mechanical arm and a transfer clamp arranged on a free end of the transfer mechanical arm. After the sub-aircraft 2 is recovered through the recovery device 3 and enters the chamber, the transfer mechanical arm transfers the sub-aircraft to an available storage position 801 of the storage system through the transfer clamp, and the sub-aircraft 2 is fixed to the storage position 801 through a fastening device at the storage position 801. For example, fastening is performed using a fastening clamp, a rope, etc.

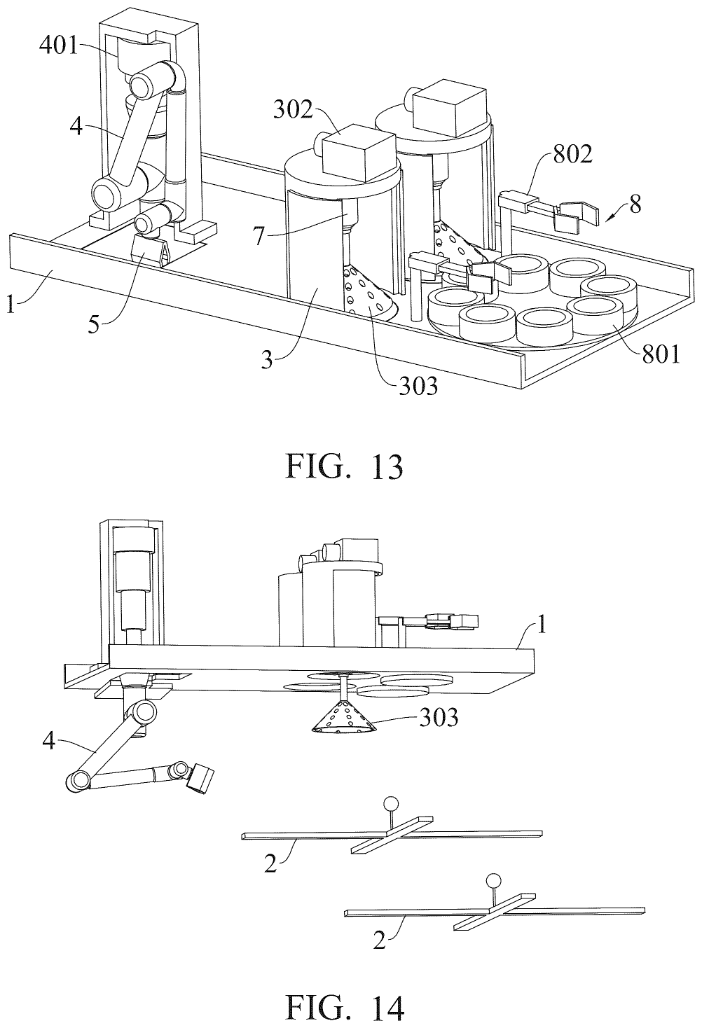

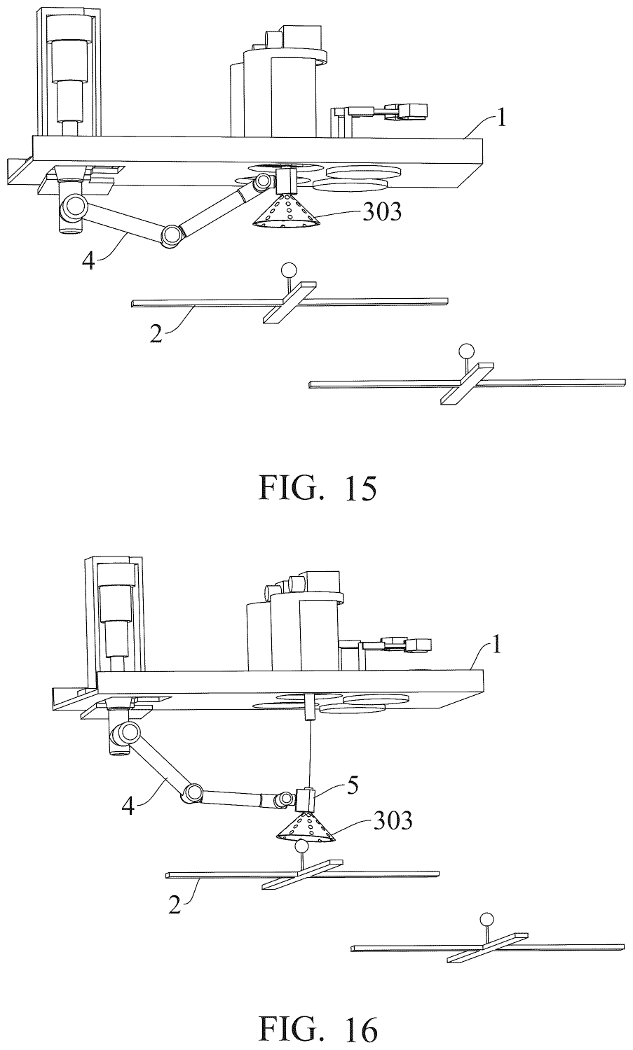

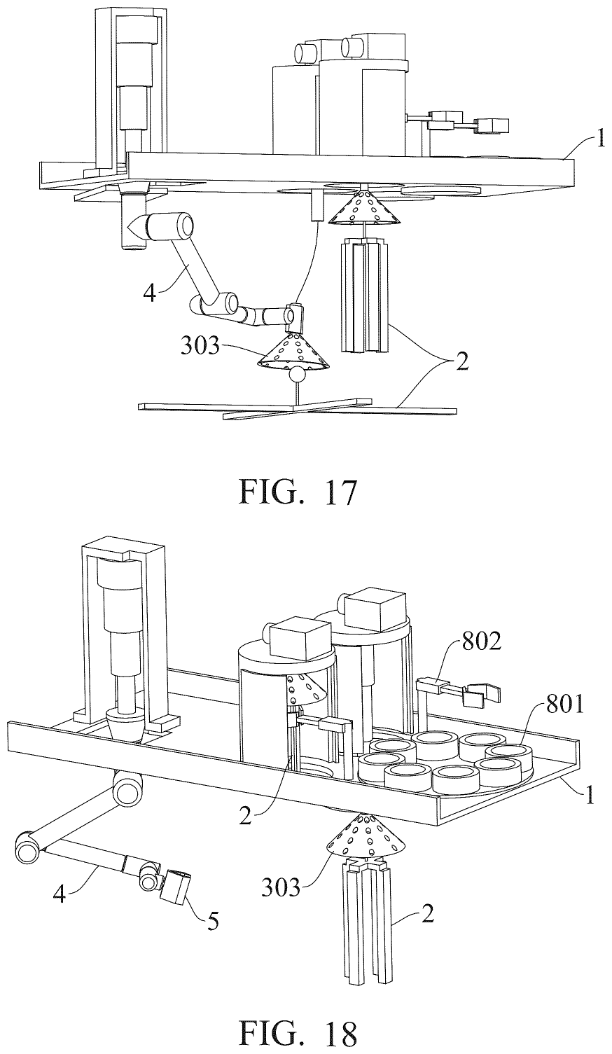

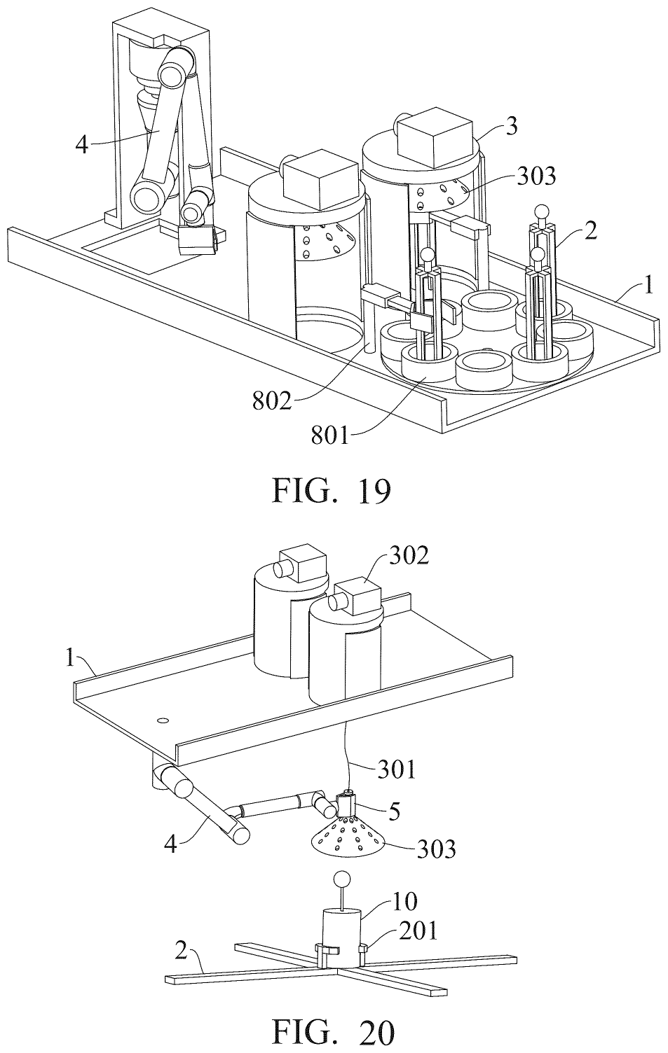

As shown in FIG. 13, the state is an initial state, in which the airborne recovery system carriers out the sub-aircraft recovery. FIGS. 14 to 19 are perspective views of a recovery process, specifically as follows:
(1) Rough formation: The sub-aircraft 2 and the carrier 1 enter a recovery-ready state. According to a presetting, the sub-aircraft 2 and the carrier 1 enter a formation state at the same speed in a designated area through their own navigation devices, with a desired position of the sub-aircraft 2 within a measurement range of the carrier 1. In this case, the carrier 1 opens a recovery chamber door, and one of the capture devices 303 of the recovery system enters a recovery preparation state. The guide arm 4 completes extension, and completes preliminary tasks such as docking with the capture device 303.
(2) Precise formation: The sub-aircraft 2 enters a detection range of the state observation device on the carrier 1, and after the state observation device confirms a desired state of the sub-aircraft 2, both parties enter a capture formation state. That is, a closer formation state is achieved according to relative state information of the sub-aircraft 2 obtained by the precision state observation device, to bring the sub-aircraft 2 within an operational range of the guide arm 4 for capture.
(3) Capture: The controller controls, based on the data fed back by the state observation device, the guide arm 4 to drive the capture device 303 to reach the desired state. According to a recovery control algorithm, the capture is implemented when a relative state of the sub-aircraft 2 and the capture device 303 proceeds to a capturable state. The selection of the capture device 303 needs to be determined based on the operational mode of the guide arm.
(4) Recovery: After the capture device 303 docks with the sub-aircraft 2, the guide arm 4 releases the capture device 303 timely and returns to the position of the available capture device 303 to acquire a new capture device 303. Meanwhile, the cable drive device 302 recovers the recovery cable 301 and pulls the sub-aircraft 2 back. Under the action of the guider 7, the sub-aircraft 2 will be located at a center of a recovery hatch, avoiding getting stuck in the recovery hatch or colliding with the carrier 1. When the sub-aircraft 2 is pulled into the chamber, the guider 7 rises accordingly until the sub-aircraft 2 completely enters the chamber. Typically, before the recovered sub-aircraft 2 enters the chamber, the sub-aircraft 2 may be actively folded through a wireless or wired communication instruction, or is automatically folded through a mechanical constraint in the recovery process, thereby lowering the requirements for a chamber space. If necessary, the guide arm 4 may follow the capture device 303 to the recovery hatch. Such an operational mode helps prevent an uncontrolled motion of the recovered sub-aircraft 2, thereby enhancing the safety of the recovery operation.
(5) After the sub-aircraft 2 is recovered into the recovery chamber, a dedicated unlocking mechanism releases a connection between the capture device 303 and the sub-aircraft 2. The sub-aircraft 2 is then transferred and stored by the storage system 8. The capture device 303 is reinitialized and enters a ready state, ready to capture the sub-aircraft 2 to be recovered.
(6) All the sub-aircrafts are recovered according to the above-mentioned recovery process, the recovery device 3 and the guide arm 4 are reset, and the hatch is closed.

In some embodiments, a plurality of sub-aircrafts 2 may enter a recovery area in formation. The carrier is provided with a plurality of recovery devices 3. According to a position of the sub-aircraft 2, the carrier 1 selects the recovery device 3 to recover the sub-aircraft 2. During recovery, the guide arm 4 acquires one capture device 303, tracks the sub-aircraft 2 using the state observation device, adjusts the position and attitude of the capture device 303, and guides the capture device 303 timely to capture the sub-aircraft 2. Once the capture device 303 captures the sub-aircraft, in the process of recovering the sub-aircraft 2 by the recovery device 3, the guide arm 4 releases the capture device 303 timely, and the captured sub-aircraft 2 continues to be recovered currently. Meanwhile, the guide arm 4 acquires another capture device 303 to continue the recovery of other sub-aircrafts 2 in the formation. During the recovery of the sub-aircrafts 2 in formation, the recovery is completed in a quasi-parallel state, enhancing the recovery efficiency. When dealing with a swarm of sub-aircrafts 2, a plurality of sets of guide arms 4 may be considered to operate simultaneously to maximize the improvement of the recovery efficiency.

In the recovery process, the guide arm 4 functions to guide and control a motion state of the capture device 303, while a load-bearing part of the recovery process is completed by the recovery device 3. In this system, the guide arm 4 only bears the load of the capture device 303, and the load capability is not affected by the weight of the sub-aircraft 2. Therefore, the guide arm 4 may be designed to be lightweight, reducing its own weight. Moreover, a single guide arm 4 may be suitable for sub-aircrafts of various models, sizes, and weights. Additionally, using a mechanical arm as the guide arm 4 provides the system with high dynamic control capability and relative state tracking precision, significantly improving dynamic control performance compared to a conventional rigid recovery system. In particular, when adopting the solution of the active capture device 304, the system exhibits excellent docking reliability and docking efficiency for the highly dynamic sub-aircraft 2. These aspects represent substantial differences from the prior art.

In conjunction with the above-mentioned embodiments of airborne recovery, the system may also recover cargo carried on the sub-aircraft. Accordingly, the cargo may be transferred from the sub-aircraft to the system in midair without the need for the carrier or the sub-aircraft to stop. There are generally two methods for transferring the cargo. One method is to recover both the sub-aircraft and the cargo carried thereon, and a recovery method is the same as that described in the above-mentioned recovery embodiments, which will not be detailed here. The second method is to recover the cargo only, a recovery method is similar to that in the above-mentioned recovery embodiments, and the sub-aircraft continues to perform other tasks. For the second method, as shown in FIG. 20, in some embodiments when implemented in conjunction with the above-mentioned embodiments, the sub-aircraft is provided with a controllable clamping device 201 for clamping cargo 10 or a container thereof and releasing the cargo 10 or the container thereof from the sub-aircraft under certain conditions. The cargo 10 or the container thereof is provided with a docking device, which may be the same as the docking device on the sub-aircraft in the above-mentioned embodiments. A recovery process of the cargo or the container thereof is similar to that of the sub-aircraft in the above-mentioned embodiments and will not be detailed here.

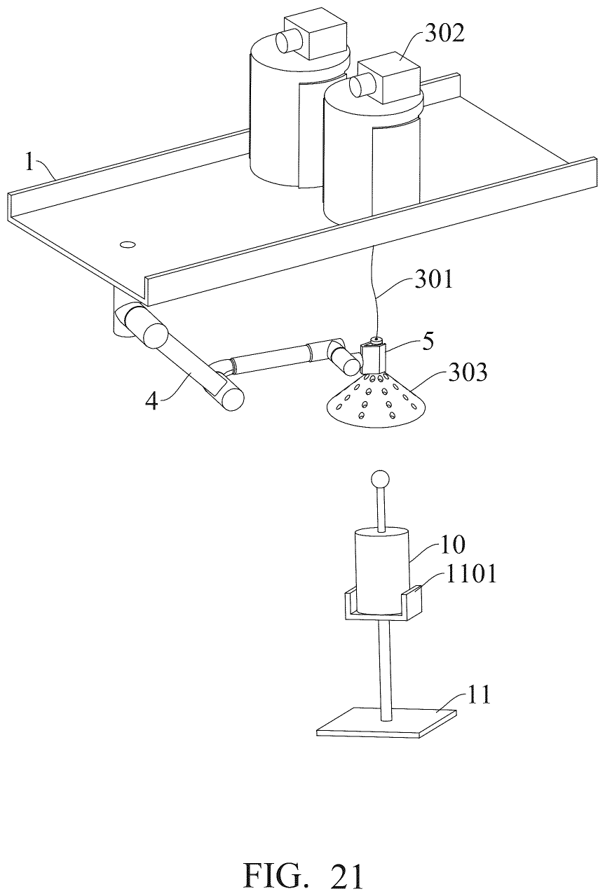

In some embodiments, the above-mentioned cargo may be placed on the ground via a carrying object, which may be, but is not limited to, a stand or fixture on the ground, or a boat on the water. This system is also applicable. As shown in FIG. 21, in some implementations, a stand 11 is arranged on the ground, and the above-mentioned cargo with the docking device is placed on the stand. The carrier takes the cargo away using the present system carried thereon, achieving an implementation of carrying the cargo without stop by the carrier. In some implementations, the stability of the cargo during docking is enhanced by the clamping device 1101 arranged on the support stand. The recovery process is similar to that in the above-mentioned embodiments, and will not be detailed here.

Compared with the prior art, the embodiments of the present disclosure have the following advantages:
1. Lightweight system: The weight of the guide arm in the system has the most significant impact on the overall system weight. Since the guide arm only bears the weight of the capture device and does not directly bear a weight of a target or an additional dynamic load after docking, and the capture device is much lighter compared to the target, the reduction in the weight of the guide arm may reach one or more orders of magnitude compared to a direct recovery solution.
2. Parallel recovery: After docking with the target, the capture device may be detached from the guide arm, thereby allowing the guide arm to be combined with other capture devices to implement subsequent capture operations, achieving simultaneous recovery of a plurality of targets.
3. Wide application scope: In this solution, since the guide arm bears the weight of the capture device only, the guide arm is not limited by the weight of the target. The recovery system of this solution may handle targets of all weight classes that the capture device can withstand. On the other hand, due to the small load on the guide arm, the guide arm can achieve larger horizontal space operations and adapt to a wider range of relative motions.
4. Good dynamic range adaptability: Since the active capture device has the capability for active capture, docking under high dynamic conditions can be achieved. Therefore, the system has good adaptability to high dynamics between the sub-aircraft and the mother aircraft.
5. High precision and reliable docking: The guide arm adopts a mechanical arm with high dynamic motion capability. Due to the high control precision of the mechanical arm, the capture device is guided to dock with the target, thereby achieving high control precision. Moreover, the capture device has a tolerance capability. A combination of the two further enhances the reliability.

Although the embodiments of the present disclosure have been shown and described, those of ordinary skill in the art should understand that these embodiments may be variously changed, modified, replaced, and transformed without departing from the principle and the spirit of the present disclosure, and the scope of the present disclosure is limited by the appended claims and equivalents thereof.

What is claimed is:

1. An airborne target recovery system, deployed on a carrier, the system comprising:
a recovery device comprising a cable and a cable drive device for releasing and retracting the cable, a tail end of the cable being provided with a capture device;
a guide arm comprising a free end selectively connected to the capture device;
a state observation device configured to acquire a state of a target; and
a controller that, based on information fed back by the state observation device, controls the guide arm to guide the capture device to a desired state for timely capturing the target, and controls the recovery device to complete the recovery of the target;
wherein the controller enables a load of the target to act on the recovery device rather than the guide arm, and the controller makes the capture device and the target be detached from the guide arm in response to the capture device capturing the target.

2. The system according to claim 1, wherein:
the free end of the guide arm is provided with an engagement device, and is configured to be selectively engaged with the capture device by the engagement device.

3. The system according to claim 1, wherein:
the guide arm comprises a multi-degree-of-freedom mechanical arm.

4. The system according to claim 3, wherein:
the guide arm further comprises a support body, the support body comprising a first end connected to the carrier and a second end connected to a fixed end of the mechanical arm.

5. The system according to claim 1, wherein:
the capture device comprises an active capture device, and the active capture device has an independent active motion capability.

6. The system according to claim 1, wherein:
the capture device comprises a passive capture device, and a motion capability of the passive capture device is determined by dynamic performance of the guide arm.

7. The system according to claim 1, wherein:
the recovery device further comprises a guider configured to guide the cable to recover the target on a set motion trajectory.

8. The system according to claim 7, wherein:
the guider comprises a multi-stage hollow telescopic rod, wherein one end of the telescopic rod is connected to the carrier, and the tail end of the cable extends through the telescopic rod and is connected to the capture device.

9. The system according to claim 8, wherein:
the telescopic rod is configured to freely extend under an action of gravity and retract along with the capture device in a target recovery process.

10. The system according to claim 1, wherein:
the airborne recovery system further comprises a docking device arranged on the target, and the docking device is connected to the capture device in cooperation to implement the capture of the target by the capture device.

11. The system according to claim 1, further comprising:
a moving device arranged on the carrier, wherein the guide arm is arranged at a movable end of the moving device, and the moving device is configured to extend a reachable range of the guide arm.

12. The system according to claim 11, wherein:
the moving device is configured to allow the guide arm to reciprocate in a longitudinal direction of the carrier and/or reciprocate perpendicular to the longitudinal direction of the carrier.

13. The system according to claim 1, further comprising:
a storage system, wherein the storage system comprises at least one storage position and a transfer device for transferring the recovered target to the storage position.

14. An airborne target recovery system, configured to be deployed on a carrier, comprising:
at least one cable comprising a first end connected to a carrier and a second end provided with a capture device; and
a guide arm comprising a free end selectively connected to one of the capture devices,
wherein the guide arm guides the capture device to a desired state to allow the capture device to capture a target timely; and the guide arm is configured to selectively release the capture device to allow a load of the target to act on the at least one cable in response to the capture device capturing the target.
